(19) United States
(12) Patent Application Publication
(10) Pub. No.: US 2003/0108682 A1
(43) Pub. Date: Jun. 12, 2003

(54) Method and apparatus for pipe processing using inert gas

(76) Inventors: Robert Lehrman, Gaitherburg, MD (US); Bill Bonham, Ijamsville, MD (US); John C. Galloway JR., Ellicott City, MD (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/012,523

(22) Filed: Dec. 12, 2001

(51) Int. Cl. B05D 3/06

(52) U.S. Cl. 427/558

(57) ABSTRACT

An apparatus is provided for cure coating a pipe or tube. This may include at least one irradiator unit to provide ultraviolet radiation, a tubular device having a window area to allow the ultraviolet radiation to pass and a cylindrical device provided within the tubular to form a curing chamber. The cylindrical device may include an open area and protective areas about a circumference of the cylindrical device. A control device may control movement (such as rotation or lateral movement) of the cylindrical device relative to the tubular device.

### BACKGROUND OF THE INVENTION

1. Field of the Invention

The present invention relates to an ultraviolet curing apparatus. More particularly, the present relates to an ultraviolet curing apparatus using an inert atmosphere chamber for pipe processing.

2. Discussion of the Related Art

It is well known to apply ultraviolet curable coating to various types of objects and to expose the same to ultraviolet radiation to produce a cured coating with desirable properties. For some curing chemistries, the presence of oxygen may inhibit the curing process, and so for such chemistries the amount of oxygen must be controlled. One way of accomplishing this is to provide a curing chamber in which a flow of nitrogen is used to displace the oxygen so that an inert atmosphere is provided. See, for example, U.S. Pat. No. 3,790,801, the subject matter of which is incorporated herein by reference.

### SUMMARY OF THE INVENTION

Embodiments of the present invention may provide an apparatus for cure coating a pipe, tube or similar object. The apparatus may include at least one irradiator unit (or ultraviolet curing lamp) to provide ultraviolet radiation. A tubular device may have a window area (such as a quartz plate) to allow the ultraviolet radiation to pass. A cylindrical device may be provided within the first device to form a cure chamber. The cylindrical device may include open areas and protective areas about a circumference of the cylindrical device. A control device may be coupled to the cylindrical device to control movement (such as rotation or lateral movement) of the cylindrical device relative to the tubular device.

The control device may move the cylindrical device at least between a first position and a second position. The open area of the cylindrical device may be circumferentially aligned with the window area of the tubular device in the first position. On the other hand, the protective area of the cylindrical device may be circumferentially aligned with the window area of the tubular device in the second position.

Still further features include that the tubular device may have a plurality of window areas such that each window area is associated with a separate irradiator unit.

The cylindrical device may include a plurality of open areas and a plurality of protective areas about a circumference of the cylindrical device. The open area may include a first opening located on a circumference of the cylindrical device, and the protective area may include material forming the circumference of the cylindrical device.

A device may provide inert gas (such as nitrogen) to an area within the cylindrical device. A feed mechanism may feed the tube or pipe to be cured through the cylindrical device.

Embodiments of the present invention may also provide an apparatus for ultraviolet cure coating a pipe, tube or similar device. This may include a first tube having a quartz plate located on an outside area of the first tube. A second tube may be provided substantially within the first tube and have an open area and a protective area about a circumference of the second tube. An inner area of the second tube may form a cure chamber. A device may rotate or laterally move the second tube relative to the first tube.

Embodiments of the present invention may also provide a method for cure coating a tube/pipe material. This may include providing the tube/pipe material into a cure chamber formed by a cylindrical device, and passing ultraviolet radiation through a quartz plate and inside a tubular device substantially surrounding the cure chamber.

Other features of the invention will become apparent from the following detailed description taken in conjunction with the annexed drawings, which disclose preferred embodiments of the invention.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto.

The following represents brief descriptions of the drawings in which like reference numerals represent like elements and wherein:

FIG. 1 illustrates a pipe processing apparatus in an open condition according to an example embodiment of the present invention;

FIG. 2 illustrates a pipe processing apparatus in closed condition according to an example embodiment of the present invention;

FIG. 3 illustrates an inner protective tube according to an example embodiment of the present invention;

FIG. 4 illustrates an outer protective tube according to an example embodiment of the present invention;

FIG. 5 is a side view of a pipe processing apparatus according to an example embodiment of the present invention;

FIG. 6 is a top view of a pipe processing apparatus according to an example embodiment of the present invention; and

FIG. 7 is an end view of the pipe processing apparatus of FIG. 6.

### DETAILED DESCRIPTION OF PREFERRED EMBODIMENTS

In the following detailed description, like reference numerals and characters may be used to designate identical, corresponding, or similar components in differing drawing figures. Furthermore, in the detailed description to follow, example sizes/models/values/ranges may be given, although the present invention is not limited thereto.

Embodiments of the present invention may hereafter be described with respect to a pipe to be cure coated. Embodiments of the present invention are also applicable to other devices to be cured coated including tubes and other similar devices.

Embodiments of the present invention may provide an inert atmosphere (such as nitrogen) in a cure chamber for ultraviolet cure coating tubes and/or pipes, for example. However, tube/pipe processing may involve open seams that may vent steam and other materials from the tubes and/or pipes. The steam and other materials may potentially damage the ultraviolet (UV) curing lamps. As such, it is desirable to protect the ultraviolet curing lamps from potential damage.

A quartz plate (also hereafter referred to as a quartz window) may be used to isolate the curing chamber for inert gas containment and to keep the steam and other materials from damaging the ultraviolet curing lamps located outside the curing chamber. The coated tube/pipe may be processed within a rotating pipe located inside of an outer protective pipe. This double pipe-in-a-pipe arrangement may include open areas for ultraviolet light or radiation to enter the curing chamber (within the center of the rotating pipe). When an appropriate signal is provided from a control module, the inner pipe may rotate so that open areas along the inner pipe may allow ultraviolet light to enter into the curing chamber. When another appropriate signal is provided from the control module, the inner pipe may rotate so that the protective areas may prevent steam and other materials from the tube/pipe being processed from damaging the ultraviolet curing lamps and the quartz windows. The ultraviolet light may also be blocked from entering the cure chamber in this position.

Embodiments of the present invention may provide an apparatus that includes at least one irradiator unit (or ultraviolet curing lamp) to provide ultraviolet radiation that will cure coat the tube, pipe or similar object. A tubular device (hereafter also called an outer tube or outer pipe) may have a quartz window to allow the ultraviolet light or radiation to pass. A rotating cylindrical device (hereafter also called an inner tube or inner pipe) may be provided within the tubular device to form a cure chamber. The tube or pipe to be processed passes through the cure chamber and may be irradiated with the ultraviolet radiation. The rotating cylindrical device may include areas to allow the ultraviolet radiation to pass through and protective areas about the circumference of the rotating cylindrical device. A control device may be coupled to the rotating cylindrical device and control rotation of the rotating cylindrical device relative to the tubular device.

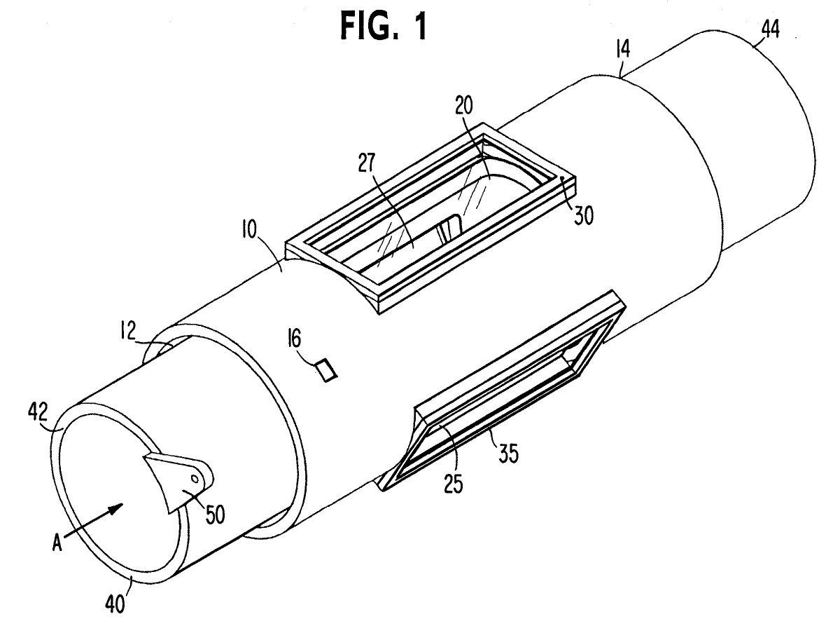

FIG. 1 illustrates a pipe processing apparatus in an open condition according to an example embodiment of the present invention. Other embodiments and configurations are also within the scope of the present invention. More specifically, FIG. 1 illustrates an outer tube (or pipe) 10 that may also be called an outer protective tube. The outer tube 10 may be cylindrical in shape having a first open end 12 and a second open end 14. An opening 16 may be provided to allow inert gas (such as nitrogen) to be pumped into the cure chamber. An inlet nozzle (not shown) may be provided within the opening 16 to pump the inert gas into the curing chamber. As shown in FIG. 1, the outer tube 10 may include a first quartz window (or plate) 20 mounted on a quartz retainer 30. FIG. 1 further illustrates a second quartz window 25 mounted to a quartz retainer 35. A third quartz window (or plate) 27 may barely be seen by observing through the first quartz window 20. Although not shown, the apparatus may also include a fourth quartz window. The outer tube 10 may include any number of quartz windows about a circumference of the outer tube 10. Each of the quartz windows 20, 25 and 27 may be associated with a separate irradiator unit (i.e., a separate ultraviolet curing lamp) that will provide ultraviolet radiation through the respective quartz windows.

FIG. 1 additionally shows an inner tube (or pipe) 40 that may also be called an inner protective tube. The inner tube 40 may be cylindrical in shape having a first open end 42 and a second open end 44. The inner tube 40 is provided within an inside circumference of the outer tube 10. The first end 42 of the inner tube 40 may extend beyond the first end 12 of the outer tube 10. The second end 44 of the inner tube 40 may extend beyond the second end 14 of the tube 10. The inner tube 40 may include a tab 50 (or other type of rotating mechanism) that may be used to rotate the inner tube 40 relative to the outer tube 10. FIG. 1 shows the tab 50 in an open position. Other mechanisms for rotating the inner tube 40 relative to the outer tube 10 are also within the scope of the present invention. Although not easily visible in FIG. 1, the inner tube 40 includes one or a plurality of open areas and one or a plurality of protective areas about a circumference of the inner tube 40. The open areas and protective areas of the inner tube 40 are strategically provided so that they may circumferentially align with the quartz windows 20, 25 and 27 when the inner tube 40 is rotated relative to the outer tube 10. The open areas may be an opening on the circumference of the inner tube 40. The open areas may also be a window formed of a material allowing ultraviolet radiation to pass.

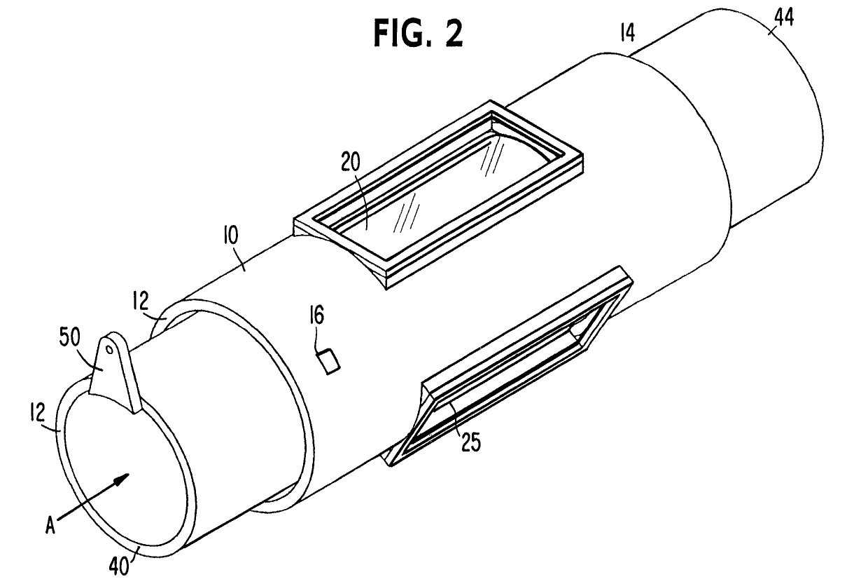

FIG. 2 illustrates the pipe processing apparatus of FIG. 1 in a closed condition according to an example embodiment of the present invention. Other embodiments and configurations are also within the scope of the present invention. FIG. 2 shows that the tab 50 has moved to a different position (hereafter called a closed position). The tab 50 thereby rotates the inner tube 40 relative to the outer tube 10. In this embodiment, the area visible through the quartz window 20 is the protective area of the inner tube 40. The protective area may be the actual material (such as steel, plastic or other materials) of the inner tube 40. The protective area may block portions of the pipe that travels through the inner tube 40 from causing damage to the quartz windows 20, 25 and 27 and the irradiator units (not shown in FIGS. 1 and 2) associated with each of the quartz windows 20, 25 and 27.

During operation, the pipe (or tube) to be cured may pass along an inside of the inner pipe 40 in a direction of arrow A. That is, the pipe or tube to be cured may pass from the first end 42 of the inner tube 40 in the direction of arrow A and exit from the second end 44 of the inner tube 40. As the tube or pipe passes through the inner tube 40, a control mechanism (not shown in FIGS. 1 and 2) may operate in conjunction with the tab 50 (or other mechanism) to position the pipe processing apparatus in an open position (FIG. 1) or in a closed position (FIG. 2). That is, as the pipe or tube travels in the direction of arrow A, the inner pipe 40 may be positioned in an open position (FIG. 1) that thereby allows ultraviolet light to pass through the quartz windows 20, 25 and 27 and through an open area of the inner pipe 40 into the curing chamber formed by the inside of the inner pipe 40. This allows the ultraviolet radiation to cure coat of the pipe as it travels in the direction of arrow A. However, there are specific times or instances in which it is not desirable to cure coat the pipe and/or it is desirable to protect the quartz windows and the irradiator units from steam or other material that may emanate from the pipe being processed. As such, the control mechanism may rotate the tab 50 and thereby rotate the inner tube 40 to a closed position (FIG. 2) that thereby positions the protective area of the inner tube 40 at areas immediately adjacent the quartz windows 20, 25 and 27. This thereby protects the quartz windows 20, 25 and 27 as well as the associated irradiator units from the pipe or tube within the curing chamber.

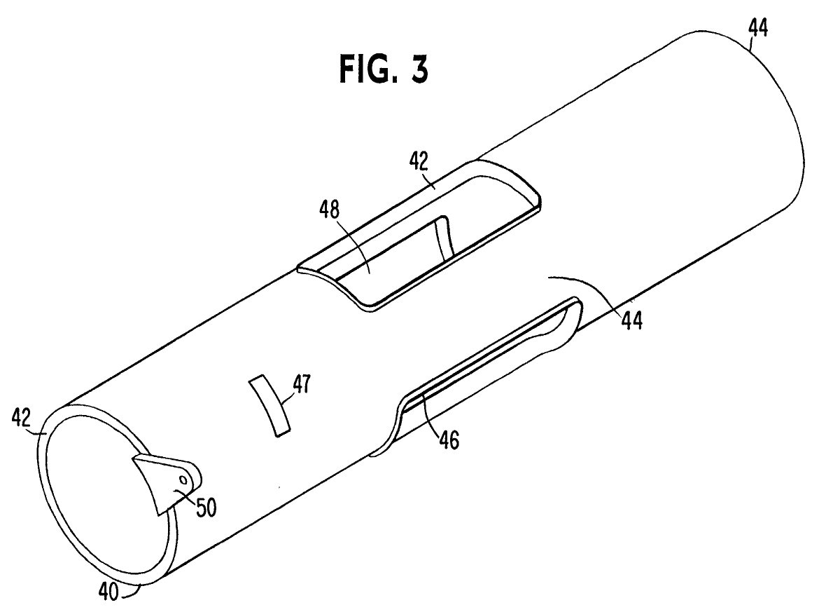

FIG. 3 illustrates an inner protective tube according to an example embodiment of the present invention. Other embodiments and configurations are also within the scope of the present invention. More specifically, FIG. 3 shows the inner tube 40 having the tab 50 mounted thereon. The tab 50 may also be a portion of the inner tube 40 that allows the control mechanism to rotate the inner tube 40 relative to the outer tube 10. The inner tube 40 may also include any other mechanism that may be coupled to a control mechanism to control the rotation of the inner tube 40. Embodiments of the present invention may also be applicable to rotation of the outer tube 10 relative to the inner tube 40 relative to the outer tube 10. Embodiments of the present invention may also be applicable to other types of movement (such as lateral) of the inner tube 40 relative to the outer tube 10. That is, the inner tube 40 may be a lateral moving pipe.

FIG. 3 additionally shows a first open area 42, a protective area 44, a second open area 46 and a third open area 48. The first open area 42 may correspond to the first quartz window 20, the second open area 46 may correspond to the quartz window 25 and the third open area 48 may correspond to the quartz window 27. The open areas 42, 46 and 48 are positioned about a circumference of the inner tube 40 SO that they correspond to areas of the quartz windows that are provided about the circumference of the outer tube 10. The open areas 42, 46 and 48 allow ultraviolet radiation to enter the curing chamber. In one embodiment, the open areas 42, 46, and 48 correspond to an opening in the material that forms the inner tube 40. The protective area 44 may be a portion of the inner tube 40 that may block ultraviolet radiation and that may protect the respective quartz windows and the associated irradiator units. During operation, the control mechanism may rotate the inner tube 40 such that either an open area (such as one of the open areas 42, 46 and 48) or the protective area 44 is appropriately aligned with a corresponding quartz window.

FIG. 3 also shows a slit 47 or other mechanism that allows the inert gas to be pumped into the curing chamber. Although not shown, an inlet nozzle may be coupled through the opening 16 on the outer tube 10 and fit within the slit 47. When the inner tube 40 rotates (and the outer tube 10 is stationary), the inlet nozzle remains within the slit 47 so that the inert gas may keep being pumped into the curing chamber. A pump may be coupled to the inlet nozzle and may be turned on or off as desired. The inlet nozzle may flood the interior of the curing chamber with the inert gas to exclude oxygen during the curing process of the product when it is subjected to the ultraviolet radiation. More than one inlet nozzle may be provided at various locations along the curing apparatus.

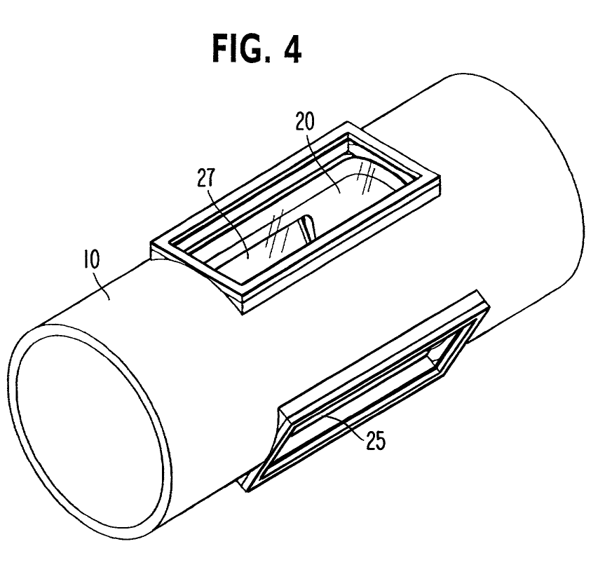

FIG. 4 illustrates an outer protective tube according to an example embodiment of the present invention. Other embodiments and configurations are also within the scope of the present invention. More specifically, FIG. 4 illustrates the outer tube 10 having the quartz window 20, the quartz window 25 and the quartz window 27.

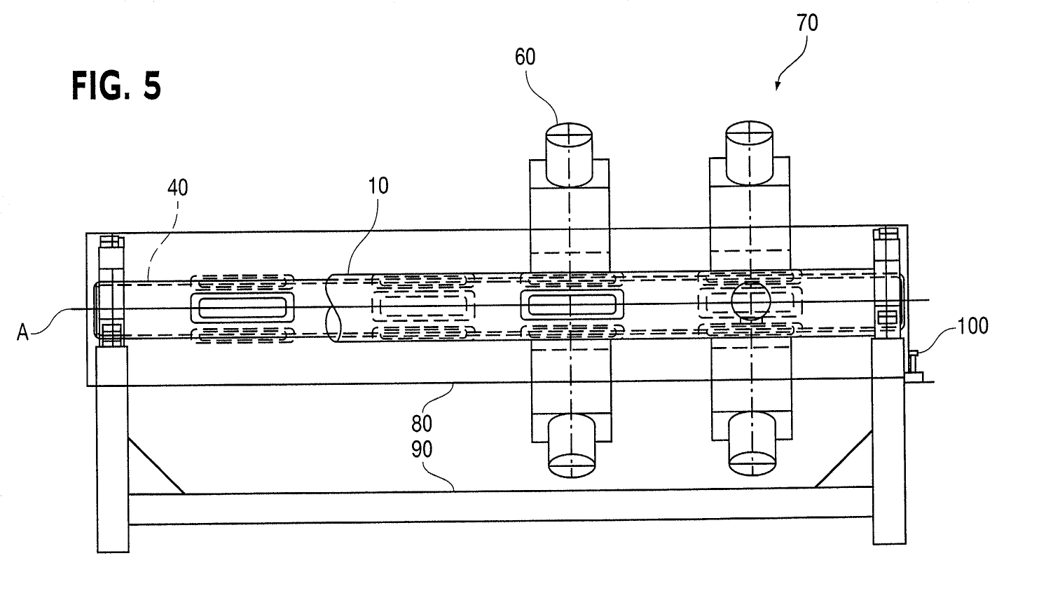

FIG. 5 is a side view of a pipe processing apparatus according to an example embodiment of the present invention. Other embodiments and configurations are also within the scope of the present invention. More specifically, FIG. 5 illustrates two sets of irradiator units (also called ultraviolet curing lamps) provided around a circumference of the outer pipe 10. Each set may include a plurality of irradiator units. The two sets of irradiator units may be provided at different angles about the outer tube 10 so as to apply ultraviolet radiation at different angles relative to the pipe (or tube) to be cured as the pipe progresses in the direction of arrow A. The pipe (or tube) may move through the curing chamber in a normal pipe processing manner. That is, in one embodiment, the pipe may be formed of molten metal and may be extruded in a continuous process to form the pipe and pass it through the curing chamber. The pipe may also be formed of a sheet of metal that is welded together and may be fed through the curing chamber.

The irradiator units may provide the ultraviolet radiation for the curing chamber. For example, the irradiator units may be microwave powered electrodeless lamps manufactured by Fusion Systems Corporation of Rockville, Md., and more particularly may be Model I600M. Other methods of UV light generators may also be employed.

FIG. 5 illustrates the outer tube 10 and the inner tube 40 provided within the outer tube 10 to form the curing chamber. A light shield 80 may be provided around the outer tube 10 and the inner tube 40 to avoid extraneous light from entering the apparatus. The pipe processing apparatus may also be provided on a frame 90. In this example, a first set of irradiator units 60 may irradiate the pipe to be cured prior to a second set of irradiator units 70 irradiating the pipe to be cured. That is, the second set of irradiator units 70 may be provided downstream (in the direction of arrow A) from the first set of irradiator units 60. As one example, the first set of irradiator units 60 may include four irradiator units provided about the circumference of the outer tube 10. Each of the irradiator units in the first set of irradiator units 60 may be associated with a quartz window provided on the outer tube 10. Accordingly, each of the irradiator units in the first set of irradiator units 60 and the associated quartz windows about the outer tube 10 may be provided at angles of approximately 0°, 90°, 180°, and 270° relative to a vertical position. As such, ultraviolet radiation may be provided by each of the irradiator units of the first set of irradiator units 60 and may pass through the respective quartz windows about the outer tube 10. The ultraviolet radiation may cure coat portions of the pipe (or tube) as it progresses in the direction of arrow A past the first set of irradiator units 60.

Operation of the tab 50 (not shown in FIG. 5) may be accomplished by use of a shutter control 100 that may include a mechanism coupled to the tab 50 and include a processor (and appropriate memory) to control rotation of the inner pipe 40 relative to the outer pipe 10. In a similar manner as discussed above, the shutter control 100 may operate to rotate the inner tube 40 relative to outer tube 10 such that protective areas rotate to a position aligned with quartz windows provided on the outer tube 10 in an area adjacent to each of the first set of irradiator units 60.

FIG. 5 additionally shows a second set of irradiator units 70 that may also include four irradiator units provided about the circumference of the outer tube 10. Each of the irradiator units in the second set of irradiator units 70 may be associated with a quartz window provided on the outer tube 10. In this example, each of the irradiator units in the second set of irradiator units 70 and the associated quartz windows about the outer tube 10 may be provided at angles of approximately 45°, 135°, 225°, and 315° relative to a vertical position. That is, each of the irradiator units may be appropriately positioned at that respective angle so that the irradiator units may irradiate ultraviolet radiation through the quartz windows provided on the outer tube 10 at those respective angles. The ultraviolet radiation may cure coat portions of the pipe as it progresses in the direction of arrow A past the second set of irradiator units 70.

In similar manner as discussed above, the shutter control 100 may operate to rotate the inner tube 40 relative to the outer tube 10 such that either open areas or protective areas are rotated to a position aligned with the quartz windows provided on the outer tube 10 in an area adjacent the irradiator units of the second set of irradiator units 70. The pipe/tube having been cure coated by the first set of irradiator units 60 and the second set of irradiator units 70 may exit out of the apparatus.

While the above embodiment have been described with respect to four irradiator units within each set of irradiator units 60, 70, embodiments of the present invention are also applicable to a different number of irradiator units provided within each set of irradiator units or to different placement of the irradiator units. For example, the first set of irradiator units 60 may include three irradiator units about the outer tube 10 at angles of approximately 0°, 120°, and 240° relative to a vertical position. Additionally, quartz windows may be provided at the same angles about the outer tube 10 to correspond with the irradiator units in the first set of irradiator units 60. In this example, the second set of irradiator units 70 may include three irradiator units about the outer tube 10 at angles of approximately 60°, 180° and 300° relative to a vertical position. Quartz windows may be provided at the same angles about the outer tube 10 to correspond with the irradiator units in the second set of irradiator units 70.

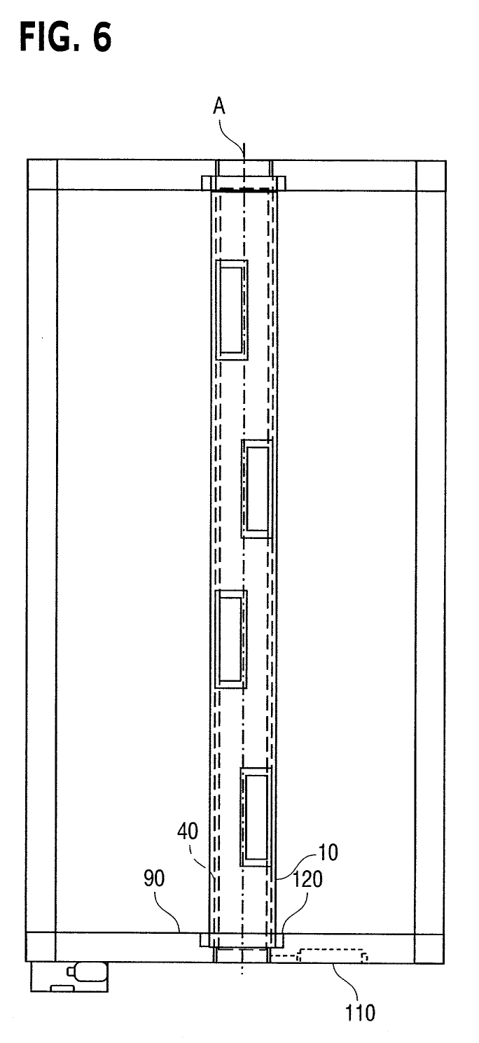

FIG. 6 illustrates a top view of a pipe processing apparatus according to an example embodiment of the present invention. Other embodiments and configurations are also within the scope of the present invention. That is, FIG. 6 illustrates the inner tube 40 provided within the outer tube 10. FIG. 6 additionally shows a shutter cylinder 110 that may be associated with the shutter control 100 (shown in FIG. 5). The shutter cylinder 110 may be coupled to a bearing 120 that may be further coupled to the tab 50 to rotate the inner tube 40 relative to the outer tube 10.

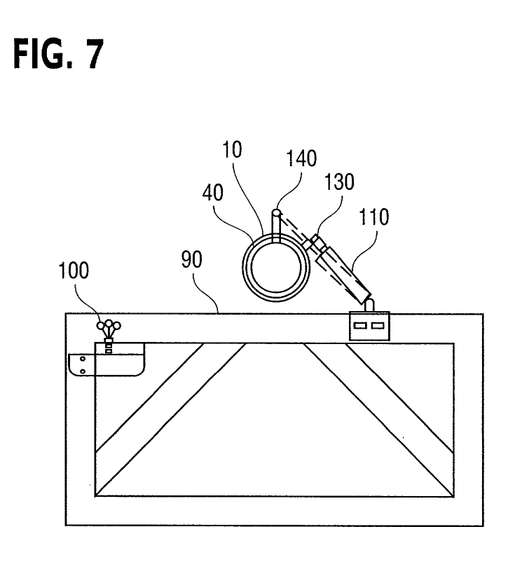

FIG. 7 is an end view of the pipe processing apparatus according to an example embodiment of the present invention. Other embodiments and configurations are also within the scope of the present invention. As may be seen, the shutter cylinder 110 may position the inner tube 40 relative to the outer tube 10. FIG. 7 specifically shows a shutter open position 130 and a shutter closed position 140. The shutter cylinder 110 may operate based on control signals sent from the shutter control 100 to appropriately position the inner tube 40 relative to the outer tube 10 in both the shutter open position 130 and the shutter closed position 140. This appropriately moves the open areas and the protective areas of the inner tube 10 relative to the quartz windows and irradiator units as described above.

Accordingly, embodiments of the present have been described with respect to an ultraviolet cure coating apparatus that includes a first tube having a quartz plate located on an outside area of the tube. A second tube may be provided substantially within the first tube and having an open area and a protective area about an outside area of the second tube. Inner areas of the second tube may form the curing chamber. A device may be provided to rotate the second tube relative to the first tube.

Embodiments of the present invention may also provide a method of cure coating a tube/pipe material. This may include providing the tube/pipe material into a curing chamber formed by a cylindrical device. The method may also include passing ultraviolet radiation through a quartz plate on a tubular device substantially surrounding the curing chamber. The method may also include rotating the cylindrical device such that a protective area of the cylindrical device is substantially aligned with the quartz plate of the tubular device.

Embodiments of the present invention have been described with respect to a rotating pipe-in-a-pipe arrangement. The inner pipe (or tube) 40 may rotate very quickly (such as less than one second) by pneumatic cylinder or electrical solenoid operation after receiving a run or close signal from the shutter control 100.

The rotating pipe-in-a-pipe arrangement may take up little space along a manufacturing line. This may be extremely important since the pipe may be unsupported during the pipe processing after the coating is applied to the pipe. Thus, a much smaller line space is very desirable.

The quartz window cure chamber may contain the inert gas (such as nitrogen) very efficiently. The design may isolate the inert gas and require much less nitrogen than conventional manners thereby reducing operational expenses. Water may not be needed as a heat exchange utility thereby reducing the complexity and operational costs.

Any reference in this description to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the knowledge of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. An apparatus for cure coating comprising:
at least one irradiator unit to provide ultraviolet radiation;
a tubular device having a window area to allow said ultraviolet radiation to pass;
a cylindrical device provided within said tubular device to form a cure chamber, said cylindrical device including an open area and protective areas about a circumference of said cylindrical device; and
a control device to couple to said cylindrical device and to control movement of said cylindrical device relative to said tubular device.

2. The apparatus of claim 1, wherein said cylindrical device comprises a rotating cylindrical device.

3. The apparatus of claim 1, wherein said cylindrical device comprises a lateral moving cylindrical device.

4. The apparatus of claim 1, wherein said control device rotates said cylindrical device at least between a first position and a second position.

5. The apparatus of claim 4, wherein in said first position, said open area of said cylindrical device is circumferentially aligned with said window area of said tubular device, and in said second position, said protective area of said cylindrical device is circumferentially aligned with said window area of said tubular device.

6. The apparatus of claim 1, wherein said window area comprises a quartz plate.

7. The apparatus of claim 1, further comprising a plurality of irradiator units each to provide ultraviolet radiation.

8. The apparatus of claim 7, wherein said tubular device has a plurality of window areas such that each window area is associated with one of said plurality of irradiator units.

9. The apparatus of claim 8, wherein said cylindrical device comprises a plurality of open areas and a plurality of protective areas about a circumference of said cylindrical device.

10. The apparatus of claim 1, wherein said open area comprises a first opening located on a circumference of said cylindrical device, and said protective area comprises material forming said circumference of said cylindrical device.

11. The apparatus of claim 1, further comprising a device to provide inert gas to an area within said cylindrical device.

12. The apparatus of claim 1, further comprising a feed mechanism to feed material to be cured through said cylindrical device.

13. An apparatus for ultraviolet cure coating comprising:
a first tube having a quartz plate located on an outside area of said first tube;
an second tube provided substantially within said first tube and having an open area and a protective area about an outside area of said second tube, an inner area of said second tube to form a curing chamber; and
a device to move said second tube relative to said first tube.

14. The apparatus of claim 13, wherein said device rotates said second tube relative to said first tube.

15. The apparatus of claim 13, wherein said device laterally moves said second tube relative to said first tube.

16. The apparatus of claim 13, wherein said open area comprises a first opening located on a circumference of said second tube, and said protective area comprises material forming said circumference of said second tube.

17. The apparatus of claim 13, further comprising an irradiating unit to provide ultraviolet radiation directed at said quartz plate.

18. The apparatus of claim 13, further comprising a device to provide inert gas to at least said curing chamber.

19. The apparatus of claim 18, wherein said inert gas comprises nitrogen.

20. The apparatus of claim 13, wherein said apparatus cure coats one of a pipe and a tube.

21. The apparatus of claim 13, wherein said device moves said second tube to a first position that allows ultraviolet radiation to pass through said open area and enter said curing chamber, and said device moves said second tube to a second position that substantially aligns said protective area of said second tube with said quartz plate of said first tube.

22. The apparatus of claim 13, further comprising a feed mechanism to feed a material to be cured through said second tube.

23. A method of cure coating a tube/pipe material comprising:
providing said tube/pipe material into a curing chamber formed by a cylindrical device; and
passing ultraviolet radiation through a quartz plate on a tubular device substantially surrounding said cure chamber.

24. The method of claim 23, wherein said ultraviolet radiation additionally passes through an open area of said cylindrical device to said cure chamber.

25. The method of claim 23, wherein said cylindrical device includes a protective area forming portions of a circumference of said cylindrical device, said method further comprising moving said cylindrical device relative to said tubular device such that said protective area of said cylindrical device is substantially aligned with said quartz plate of said tubular device.

26. The method of claim 23, further comprising providing an inert gas in said curing chamber.

27. A method of cure coating comprising:
providing a material into a curing chamber formed by a cylindrical device having an open area and a protective area; and
moving said cylindrical device relative to a tubular device to allow ultraviolet radiation to pass through said open area.

28. The method of claim 27, wherein moving said cylindrical device comprises rotating said cylindrical device relative to said tubular device.

29. The method of claim 27, wherein moving said cylindrical device comprises laterally moving said cylindrical device relative to said tubular device.

30. The method of claim 27, wherein said ultraviolet radiation passes through a quartz plate located on said tubular device.

31. The method of claim 30, further comprising moving said cylindrical device relative to said tubular device such that said protective area aligns with said quartz plate.

32. The method of claim 27, further comprising providing an inert gas in said curing chamber.

33. The method of claim 27, wherein said material comprises a pipe/tube material.
